(19) United States
(12) Patent Application Publication
(10) Pub. No.: US 2014/0154518 A1
(43) Pub. Date: Jun. 5, 2014

(54) BARRIER FILM AND METHOD OF MANUFACTURING THE SAME

(71) Applicant: SAMSUNG ELECTRONICS CO., LTD., Suwon-si (KR)

(72) Inventors: Tomoyuki KIKUCHI, Yokohama (JP); Kenichi NAGAYAMA, Yokohama (JP)

(73) Assignee: SAMSUNG ELECTRONICS CO., LTD., Suwon-si (KR)

(21) Appl. No.: 14/094,164

(22) Filed: Dec. 2, 2013

(30) Foreign Application Priority Data
Dec. 3, 2012 (JP) 2012-264551
Oct. 23, 2013 (KR) 10-2013-0126512

(51) Int. Cl. C08J 5/18; B32B 27/28

(52) U.S. Cl. CPC C08J 5/18; B32B 27/283
USPC 428/447; 522/172; 428/216; 428/336; 428/323

(57) ABSTRACT

A barrier film including a plurality of cured layers each cured layer including a curing product of a polysilazane photocurable precursor, an uncured layer disposed between a first and a second cured layer of the plurality of cured layers, the uncured layer including the polysilazane photocurable precursor, and a gradient composition layer disposed between the first and the second cured layer and the uncured layer, wherein a concentration of the polysilazane photocurable precursor in the gradient composition layer increases with a distance from the first and the second cured layers toward the uncured layer.

### CROSS-REFERENCE TO RELATED APPLICATION

This application claims priority to Japan Patent Application No. 2012-264551 filed in the Japanese Intellectual Property Office on Dec. 3, 2012, and Korean Patent Application No. 10-2013-0126512 filed in the Korean Intellectual Property Office on Oct. 23, 2013, and all the benefits accruing therefrom under 35 U.S.C. 119, the contents of which are incorporated herein in their entirety by reference.

### BACKGROUND

1. Field of the Invention

A barrier film and a method of manufacturing the same are disclosed.

2. Description of the Related Art

A barrier film, including a barrier layer on a resin film, has been used for a flexible substrate for an electronic device. This barrier film has also been used for packaging of foods and the like, and recently has been used in an electronic device. Accordingly, the barrier film is desired to have remarkably improved barrier performance against moisture or gas molecules such as oxygen and the like. The barrier film is known to be manufactured by a method using a vacuum process. The vacuum process is basically a process of attaching a material including the barrier film on a film substrate in a vacuum chamber. However, the vacuum process has a fundamental problem of flatness deterioration, for example when foreign particles (referred to as particles, impurities, and the like) are included.

Thus, there remains a need of a barrier film having low vapor permeability, which could be utilized in various electronic devices.

### SUMMARY

In order to provide an improved barrier film, it is suggested that the thickness of the barrier film should be made thicker. For methods of making the barrier film thicker, the following have been suggested: a method of making a precursor layer consisting of thick polysilazane and irradiating ultraviolet (UV) rays to the precursor layer, and a method of stacking multiple barrier films.

However, the stacking multiple films may have problems that cracks may be easily generated since a large amount of stress may be applied in a precursor layer while irradiating ultraviolet (“UV”) rays. In the latter method, while stacking the barrier films, foreign particles may be included, and pinholes and cracks caused by the foreign particles may be generated. Accordingly, stacked barrier films may not be applicable to a barrier film for an electronic device.

Herein, a barrier film that suppresses generation of pinholes and cracks and has improved gas barrier properties, and a method of manufacturing the same, are provided.

According to an aspect, a barrier film includes:

a plurality of cured layers each cured layer including a curing product of a polysilazane-containing photocurable precursor;

an uncured layer disposed between a first and a second cured layer, the uncured layer including the polysilazane photocurable precursor; and

a gradient composition layer disposed between the first and the second cured layer and the uncured layer,

wherein a concentration of the polysilazane photocurable precursor in the gradient composition layer increases with a distance from the first and the second cured layers toward the uncured layer.

The barrier film may include the plurality of cured layers, uncured layers, and gradient composition layers. That is, the barrier film may have a multi-layer structure. Therefore, the barrier film may have improved barrier properties. In addition, in the barrier film, the uncured layer and the gradient composition layer may function as a stress buffer layer, and thus crack generation may be suppressed. Since the barrier film is manufactured by irradiating ultraviolet (UV) rays to a single precursor layer, mixing of foreign particles may be suppressed, and furthermore, generation of cracks and pinholes by foreign particles may be suppressed.

Herein, a layer thickness of the cured layer may be about 20 nanometers to about 250 nanometers. In this aspect, because the layer thickness of the cured layer is within about 20 nanometers to about 250 nanometers, crack generation may be suppressed.

A layer thickness of the gradient composition layer may be within about 20 nanometers to about 100 nanometers. In this aspect, because the layer thickness of the gradient composition layer is within about 20 nanometers to about 100 nanometers, crack generation may be further suppressed.

A layer thickness of the uncured layer may be within about 5 nanometers to about 150 nanometers. In this aspect, because the layer thickness of the uncured layer is within about 5 nanometers to about 150 nanometers, crack generation may be further suppressed.

Each of the cured layers, the uncured layer, and the gradient composition layer may include silicone and oxygen, nitrogen, or a combination thereof. In this aspect, because the uncured layer and the gradient composition layer include silicon, oxygen, and nitrogen, barrier properties of the barrier film may be improved and crack generation may be suppressed.

In another aspect, the gradient composition layer includes the silicon atoms, the oxygen atoms, and the nitrogen atoms,

wherein a concentration of the nitrogen in the gradient composition layer increases as a distance from the first and second cured layers toward the uncured layer, and

wherein the concentration of the nitrogen ranges from about 0 atomic % to about 20 atomic % based on the total number of atoms in the vertical cross-sectional area. In this aspect, the gradient composition layer includes the silicon atoms, the oxygen atoms, and the nitrogen atoms, a nitrogen atom concentration in each internal area increases as a distance from the cured layer toward the uncured layer is increased, and the concentration of the nitrogen atoms ranges from about 0 atomic % to about 20 atomic % based on the total number of atoms in the vertical cross-sectional area of the gradient composition layer. Accordingly, the gradient composition layer may function as a stress buffer layer, and furthermore crack generation may be suppressed.

The uncured layer includes silicon atoms, oxygen atoms, and nitrogen atoms, and a concentration of the nitrogen in the uncured layer ranges from about 10 atomic % to about 40 atomic % based on the total number of atoms in the vertical cross-sectional area. In this aspect, the uncured layer includes the silicon atoms, the oxygen atoms, and the nitrogen atoms, and a concentration of the nitrogen in the uncured layer ranges from about 10 atomic % to about 40 atomic %. Accordingly, the uncured layer may function as a stress buffer layer, and furthermore crack generation may be suppressed.

The barrier film may further include an alternative stacking film including a sheet-shaped particle layer including charged sheet-shaped particles, and a binder layer having a charge opposite to a charge of the sheet-shaped particles, and the alternative stacking film may be stacked on the cured layer. In this aspect, the barrier film may have improved barrier properties due to the alternative stacking film.

The sheet-shaped particles may be inorganic sheet-shaped particles. In this aspect, because the sheet-shaped particles of the alternative stacking film are inorganic sheet-shaped particles, barrier properties of the barrier film may be further improved.

In another aspect, a method of manufacturing the above barrier film includes irradiating ultraviolet rays onto a polysilazane-containing photocurable precursor layer

wherein an exposure dose of the ultraviolet rays is larger is in a range from about 0.3 joules per square centimeter to about 65 joules per square centimeter, and

wherein the exposure dose of the ultraviolet rays increases as a thickness of the precursor layer increases.

In this aspect, the barrier film may be manufactured by irradiating ultraviolet rays onto the polysilazane-containing photocurable precursor layer wherein an exposure dose of the ultraviolet rays increases as the thickness of the precursor layer increases, and is within about 0.3 joules per square centimeter to about 65 joules per square centimeter. Accordingly, the barrier film may be manufactured by a simple process. The barrier film may have improved barrier properties due to a multi-layer structure. In addition, the barrier film is manufactured by irradiating ultraviolet rays onto a single precursor layer, and thus mixing in of foreign particles may be suppressed, and furthermore, generation of cracks and pinholes by foreign particles may be suppressed.

Also disclosed is a method of manufacturing of a barrier film, the method including: forming a polysilazane photocurable precursor layer; and irradiating ultraviolet rays onto the polysilazane-containing photocurable precursor layer to manufacture the barrier film, wherein an exposure dose of the ultraviolet rays ranges from about 0.3 joules per square centimeter to about 65 joules per square centimeter, and wherein the exposure dose of the ultraviolet rays increases as a thickness of the precursor layer is increased.

Also disclosed is an electronic device including the barrier film.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a cross-sectional view showing a structure of an embodiment of a barrier film;

FIG. 2 is a cross-sectional view showing a structure of another embodiment of a barrier film;

FIG. 3 is a graph of atomic concentration (atomic percent, atomic %) versus depth (nanometer, nm) showing a relationship between each atom concentration of the barrier films according to Examples 1 and 3 and a depth from the surface of the barrier films;

FIG. 4 is a graph of atomic concentration (atomic percent, atomic %) versus depth (nanometer, nm) showing a corresponding relationship between each atom concentration of the barrier films according to Example 2 and a depth from the surface of the barrier film;

FIG. 5 is a graph of atomic concentration (atomic percent, atomic %) versus depth (nanometer, nm) showing a corresponding relationship between each atom concentration of the barrier films according to Example 4 and a depth from the surface of the barrier film;

FIG. 6 is a graph of concentrations of elements (atomic percent, atomic %) versus depth (nanometer, nm) showing a corresponding relationship between each atom concentration of the barrier films according to Comparative Example 1 and a depth from the surface of the barrier film; and

FIG. 7 is a cross-sectional view showing states of cracks and pinholes generated by foreign particles in a prior art barrier film.

### DETAILED DESCRIPTION

The present disclosure will be described more fully hereinafter with reference to the accompanying drawings, in which exemplary embodiments of this disclosure are shown. However, these embodiments are only exemplary, and the present disclosure is not limited thereto but rather is defined by the scope of the appended claims. In the present disclosure and drawings, constituent elements having substantially equivalent functions are assigned the same reference number and thus redundant descriptions are omitted.

Accordingly, the embodiments are merely described below, by referring to the figures, to explain aspects of the present description. As used herein, the term “and/or” includes any and all combinations of one or more of the associated listed items. The term “or” means “and/or.” Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be further understood that the terms “comprises” and/or “comprising,” or “includes,” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Alkyl” as used herein means a straight or branched chain, saturated, monovalent hydrocarbon group (e.g., methyl or hexyl).

“Alkenyl” means a straight or branched chain, monovalent hydrocarbon group having at least one carbon-carbon double bond (e.g., ethenyl (—HC═CH₂)).

“Alkynyl” means a straight or branched chain, monovalent hydrocarbon group having at least one carbon-carbon triple bond (e.g., ethynyl).

“Arylalkylene” group is an aryl group linked via an alkylene moiety. The specified number of carbon atoms (e.g., C7 to C30) means the total number of carbon atoms present in both the aryl and the alkylene moieties.

“Cycloalkyl” means a monovalent group having one or more saturated rings in which all ring members are carbon (e.g., cyclopentyl and cyclohexyl).

“Aryl” means a monovalent group formed by the removal of one hydrogen atom from one or more rings of an arene (e.g., phenyl or naphthyl).

“Alkylsilyl,” refers to a group of the formula —Si(R)ₓH_{y}, wherein 1<x<3 and y=3-x, and wherein each R is independently selected from the alkyl, alkenyl, alkynyl, or aryl, or arylalkylene.

“Alkylamino” as used herein means an alkyl group, as defined above, having an amino group, preferably 1 to about 3 or 4, attached thereto.

“Alkoxy” means an alkyl group that is linked via an oxygen (i.e., alkyl-O—), for example methoxy, ethoxy, and sec-butyloxy groups. Atomic concentration may be indicated in units of mass percent (mass %) or atomic percent (atomic %). The atomic concentration may be measured using, for example, X-ray photoelectron spectroscopy (“XPS”). An atomic concentration may be determined based on a ratio of an atom number relative to the total atom number in the cross-section (internal area) in a thickness direction of the multi-layered barrier film.

A barrier film including a barrier layer on a resin film is used as a flexible substrate for an electronic device. This type of barrier film has been used to wrap food and the like, and more recently has been used for an electronic device where remarkably improved barrier performance is desired. For example, a barrier film for an organic electro-luminescent device, which is a solid-state light emitting device known to be preferable for a flexible display, desirably provides a water vapor transmission rate (“WVTR”) of about 1×10⁻⁶ grams per meter per day (g/m²/day).

Various barrier films claiming such WVTRs have been produced by several companies. For example, American Vitex Co. discloses a barrier film in which a resin film and an alumina layer are alternatively stacked. According to Vitex, the barrier film has sufficiently high performance to be applicable to an organic light emitting diode. In addition, Mitsubishi Co. has announced a barrier film having a WVTR of 0.05 g/m²/day.

Starting from these two technologies, many high performance barrier films have been manufactured using a vacuum process. The vacuum process is basically a process of attaching a material including the barrier film to a film substrate in a vacuum chamber. The vacuum process usually requires a sizeable vacuum chamber, thus has a problem of a high cost of equipment. In addition, maintenance of the vacuum chamber for the vacuum process is expensive and resultantly increases a manufacturing cost of the barrier film. Furthermore, the vacuum process does not have good step coverage for manufacturing a barrier film and easily generates cracks and pinholes due to presence of foreign particles on a substrate, reducing flatness.

Alternatively, a wet process can be used to manufacture a barrier film. This wet process may avoid the problems of the vacuum process and form a barrier film having fewer pinholes with a lower cost. The wet process may use a sol-gel method or clay particles almost no gas transfer. A method of manufacturing a barrier film using this wet process is disclosed in Japanese Patent Publication No. 2007-22075, Japanese Patent Publication No. 2003-41153, and U.S. Patent Publication No. 2004/053037, the contents of which are incorporated herein by reference in their entirety.

Japanese Patent Publication No. 2007-22075 discloses a barrier film in which a clay layer formed of clay particles and an inorganic layer formed by a sol-gel method are stacked. According to Japanese Patent Publication No. 2007-22075, the clay layer is formed by applying a dispersion in which clay particles are dispersed. However, the clay layer has a problem of being not well bonded to an adjacent layer, that is, the inorganic layer. In addition, the clay layer is formed by depositing clay particles, and the clay particles are very weakly bonded in the clay layer. For example, when moisture is permeated into the clay layer through the inorganic layer, water molecules break into the clay particles and swell the clay layer, sharply deteriorating barrier film barrier performance. In order to solve this problem, water permeability of the inorganic layer may be decreased, but the inorganic layer is disclosed as being baked at a high temperature (about 100 to about 500° C.), further complicating the process.

Japanese Patent Publication No. 2003-41153 discloses a barrier film formed of a mixture of a sol-gel material and clay particles. According to Japanese Patent Publication No. 2003-41153, barrier film barrier performance may be improved by dispersing the clay particle in the sol-gel material in a high concentration. J. MACROMOL. SCI. (CHEM.), A1 5, 929-942, 1967, the content of which is incorporated herein by reference in its entirety, shows how much barrier performance may be improved when a layered compound like the clay particles is dispersed in the sol-gel material. According to a calculation in the article, as an example, use of about 20 mass percent (“mass %”) of clay particles having a diameter of 1 micrometer (μm) and a thickness of 1 nanometer (nm), when disposed in a sol-gel material, is sufficient to decrease the WVTR of a barrier film including the sol-gel material. In addition, the dispersion prepared by dispersing the clay particles having a very flat shape in the sol-gel material has a thixotropic characteristic and a high viscosity when stationary. Accordingly, the 20 mass % of the clay particles may not be actually dispersed in the sol-gel material due to this high viscosity. The clay particles in the dispersion, even if they can be dispersed, may be disposed into a layer due to the high viscosity.

U.S. Patent Publication No. 2004/053037 discloses a barrier film formed by alternately adsorbing a clay layer including clay particles and a cationic resin. However, the barrier film of U.S. Patent Publication No. 2004/053037 includes the cationic resin having high gas permeability in a barrier layer and passing moisture and the like and a gas. Accordingly, the barrier film of U.S. Patent Publication No. 2004/053037 has a problem of insufficient barrier performance in each clay layer. In order to solve this problem, more clay layers may be stacked, but this causes another problem of complicating the process and thickening the barrier film.

Japanese Patent Publication No. 2008-159824 and Japanese Patent Publication No. 2003-41153, the contents of which are incorporated herein by reference in their entirety, disclose a technology to manufacture a barrier film consisting of a single layer of silicon dioxide by irradiating ultraviolet (UV) rays on to polysilazane. The technology disclosed in these patent references shows that the problem of flatness deterioration due to mixing of foreign particles may be decreased. In addition, the technology disclosed in the patent references shows that polysilazane may be converted into silica at a lower temperature by direct oxidization without dehydration condensation. Accordingly, the technology disclosed in these patent references is considered to be very effective for forming a barrier film.

However, the barrier films disclosed in Japanese Patent Publication No. 2008-159824 and Japanese Patent Publication No. 2003-41153 have very high vapor permeability. Accordingly, the barrier films disclosed in Japanese Patent Publication No. 2008-159824 and Japanese Patent Publication No. 2003-41153 are not suitable for an electronic device.

In order to solve these and other problems, it is suggested that the thickness of a barrier film should be greater. As a method of making a thicker barrier film, the following are suggested: a method of making a thicker precursor layer consisting of polysilazane and irradiating ultraviolet (UV) rays on to the precursor layer, and a method of stacking multiple barrier films.

However, the former method may have problems because cracks may be easily generated since a large amount of stress may be applied in a precursor layer while irradiating ultraviolet (UV) rays. In the latter method, while stacking of barrier films, foreign particles may be mixed, and pinholes and cracks caused by the foreign particles may be generated. Accordingly, barrier films disclosed in Japanese Patent Publication No. 2008-159824 and Japanese Patent Publication No. 2003-41153 may not be suitable for a barrier film for an electronic device.

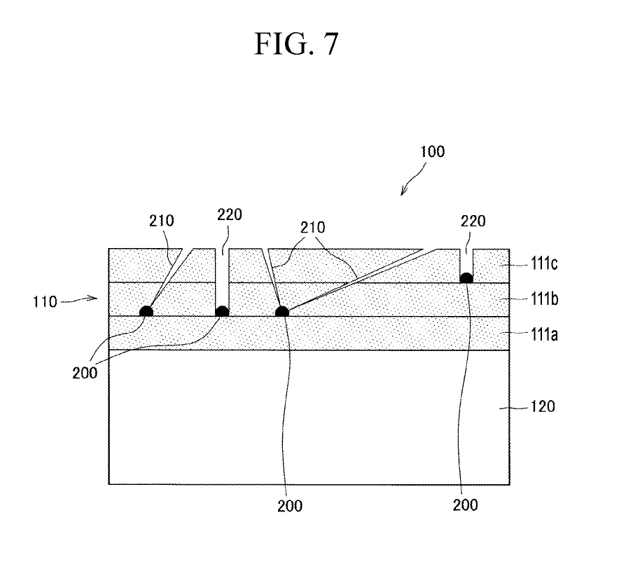

FIG. 7 is an assembly 100 including a barrier film 110 disposed on a substrate 120. Referring to FIG. 7, states of cracks and pinholes generated by mixing of foreign particles in a prior art barrier film are described.

In FIG. 7, the barrier film 110 is obtained by stacking three layers of a barrier film, which disclosed in Japanese Patent Publication No. 2008-159824 and Japanese Patent Publication No. 2003-41153, on a substrate 120. Referring to FIG. 7, when a first barrier film 111a is stacked on a second barrier film 111b, and a third barrier film 111c is stacked on the second barrier film 111b, foreign particles 200 are included between the first, second, and/or third barrier films 111a, 111b, and/or 111c, thus a generating crack 210 or a pinhole 220. In addition, FIG. 7 shows that a high stress is generated at an interface between adjacent barrier films, producing a crack. Specifically, each barrier film is disposed by forming a polysilazane precursor layer and irradiating ultraviolet (UV) rays to the polysilazane precursor layer. The ultraviolet (UV) irradiation of the precursor layer converts polysilazane into silica and forms the barrier film 111. The precursor layer greatly contracts during the conversion reaction into silica and generates high internal stress. This internal stress generates cracks.

As a result of considering the above problems, in this disclosure, it is suggested that a silicon oxide layer having a multi-layer structure may be manufactured from a single layer of a polysilazane precursor layer by controlling an exposure dose of ultraviolet (UV) rays according to a thickness of a polysilazane precursor layer. Accordingly, an improved barrier film is provided. Hereinafter, the present embodiment is further disclosed.

Polysilazane

A barrier film according to the present embodiment is manufactured by irradiating ultraviolet (UV) rays on to a precursor layer including a polysilazane. Accordingly, first, the polysilazane is described.

The polysilazane is a photocurable inorganic polymer having a silicon-nitrogen bond, and in addition to the Si—N bond, has a Si—H bond, and/or a N—H bond, and the like. The polysilazane may be a precursor of SiO₂, Si₃N₄, and an intermediate solid solution of the two, SiOₓN_{y}, and the like, wherein x is 0 to 2 and y is 0 to 4/3. The polysilazane may, for example, have a repeating unit represented by Chemical Formulas 1 and/or 2, and may be soluble in various solvents.

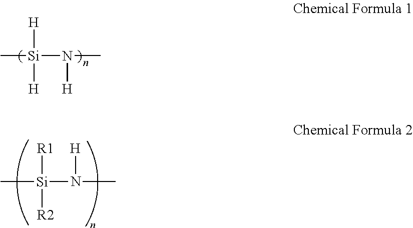

In Chemical Formula 2, R¹ and R² are each independently hydrogen, an alkyl group, an alkenyl group, a cycloalkyl group, an aryl group, an alkylsilyl group, an alkylamino group, an alkoxy group, and the like. In an embodiment, a perhydropolysilazane (“PHPS”) wherein R¹ and R² are each hydrogen is particularly suitable to provide a dense barrier film.

The perhydropolysilazane may have a linear structure, a ring structure including a 6- and/or 8-membered ring, or a combination thereof. A representative perhydropolysilazane is commercially available in a form of a solution in an organic solvent. In an embodiment, the commercially available product may be used as a polysilazane-containing coating solution as received.

A weight average molecular weight of the polysilazane is not particularly limited, and may be, for example, about 600 to about 3,000 Daltons (Da), or about 700 to about 2,500 Da, or about 800 to about 2,000 Da. A content of the polysilazane in the polysilazane-containing coating solution is not particularly limited, and for example, may be about 0.1 to about 35 mass %, for example, about 0.5 to about 10 mass %, based on the total mass of the coating solution. Within the above ranges of the weight average molecular weight and content, a barrier film may be easily manufactured, and barrier properties of a barrier film may be improved.

A solvent for the polysilazane-containing coating solution may be any suitable solvent, e.g., those that do not easily reacts with the polysilazane, for example, an alcohol, water, and the like). A suitable solvent may be, for example, a hydrocarbon solvent such as an aliphatic hydrocarbon, an alicyclic hydrocarbon, an aromatic hydrocarbon, or the like, or a halogenated hydrocarbon solvent, or an ether, for example, an aliphatic ether, an alicyclic ether, or the like, or a combination thereof. Such a solvent may, for example, be pentane, hexane, cyclohexane, toluene, xylene, an aromatic-based solvent (e.g., the ExxonMobil product Solvesso™, and the like), methylene chloride, trichloroethylene, dibutylether, dioxane, tetrahydrofuran, and the like, or a combination thereof. These solvents may be selected in accordance with the solubility of the polysilazane and an evaporation rate of the solvent. A combination of the foregoing solvents may be used.

In an embodiment, various catalysts may be added to the coating solution in order to promote conversion of the polysilazane into silica. Such a catalyst may be an amine, a metal carbonate salt, and the like, or a combination thereof. The catalyst is listed in, for example Japanese Patent Publication No. 11-116815, Japanese Patent Publication No. 9-31333, the contents of which are incorporated herein by reference in their entirety, and the like, and in the present embodiment, any suitable catalyst listed in these references may be used.

The polysilazane coating solution may be, for example, AQUAMICA™ NAX120-20, NN110, NN310, NN320, NL110A, NL120A, NL150A, NP110, NP140, SP140, and the like of the AZ Electronic Materials Company. Among them, NN120, NN110, and the like forming perhydropolysilazane without a catalyst may be suitable for a coating solution for manufacturing the barrier film. A dense barrier film having high barrier properties may be manufactured using the coating solution.

Structure of the Barrier Film

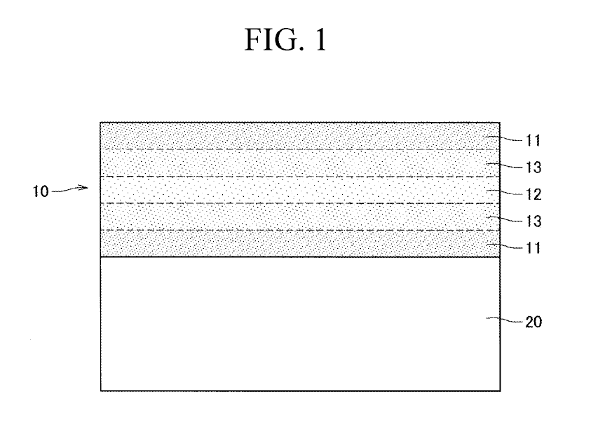

Next, referring to FIG. 1, a structure of a multi-layered barrier film 10 according to an embodiment is further disclosed.

The multi-layered barrier film 10 is disposed on, e.g., formed on, for example, a substrate 20. The substrate 20 may be hygroscopic. The substrate 20 may contain moisture, which may promote conversion of the polysilazane into silica.

A resin constituting the substrate 20 may be, for example, polyethylene terephthalate (“PET”), polyethylene naphthalate (“PEN”), polyether sulfone (“PES”), polyimide (“PI”), or a combination thereof.

The multi-layered barrier film 10 includes a cured layer 11, an uncured layer 12, and a gradient composition layer 13.

Each layer includes silicon and at least one of oxygen and nitrogen. That is, each layer may include one of a silicon oxide compound, e.g., SiOₓ, a silicon nitride compound, e.g., SiN_{y}, or a silicon oxynitride compound, e.g., SiOₓN_{y}.

In an embodiment, because the multi-layered barrier film 10 is manufactured from the polysilazane-containing photocurable precursor, the possibility of inclusion of a foreign particle into a barrier film may be reduced compared to a stacked film, such as the barrier films disclosed in Japanese Patent Publication No. 2008-159824 and Japanese Patent Publication No. 2003-41153. In addition, when the precursor layer is merely made to be thicker, cracks may be generated during irradiation of ultraviolet (UV) rays. In contrast, in the present embodiment, the gradient composition layer 13 makes the cured layer 11 and the uncured layer 12 to be close to each other, and thereby functions as a stress buffer layer. The uncured layer 12 also functions as a stress buffer layer. Accordingly, even though the multi-layered barrier film 10 becomes thicker, crack generation may be suppressed. The multi-layered barrier film 10 includes a plurality of layers formed by conversion of the polysilazane into silica, and thus has improved barrier properties compared to barrier films of Japanese Patent Publication No. 2008-159824 and Japanese Patent Publication No. 2003-41153, that is, a barrier film including a single layer of silicon dioxide.

A film thickness of the multi-layered barrier film 10 is not particularly limited, but may be about 30 nm to about 750 nm, for example, about 40 nm to about 600 nm, and for example, about 45 nm to about 500 nm.

The cured layer 11 is formed by curing polysilazane, and is formed on the surface of multi-layered barrier film 10 and on a rear side (a side contacting the substrate 20). The cured layer 11 is, for example, an inorganic layer consisting of silicon atoms (Si) and oxygen atoms (O). An atomic content ratio O/Si of the oxygen atoms to the silicon atoms is not particularly limited, and may be 1<O/Si<2, for example 1.5<O/Si≦2. When the atomic content ratio O/Si of the silicon atoms and the oxygen atoms is within these ranges, barrier properties of the multi-layered barrier film 10 may be further improved.

A thickness of the cured layer 11 is not particularly limited, and may be about 20 to about 250 nm, and for example, about 30 to about 200 nm, which may be suitable for crack suppression.

A thickness of the cured layer 11 is a distance (depth) from the surface of the cured layer 11 (e.g., a surface or a rear side of the multi-layered barrier film 10) to the surface of the gradient composition layer 13 that is closest to the cured layer 11 (e.g., a side facing the cured layer 11).

The thickness of the cured layer 11 may be controlled by an exposure dose of ultraviolet (UV) rays. The exposure dose may, for example, be about 0.3 to about 65 Joules per square centimeter (J/cm²), for example, about 2 to about 45 J/cm², or for example, about 5 to about 38 J/cm² so that the layer thickness of the cured layer 11 may be within the above range.

As the exposure dose is increased, the thickness of the cured layer 11 also increases. In addition, as the thickness of the polysilazane precursor layer increases, the thickness of the cured layer 11 at the same exposure dose decreases.

The uncured layer 12 is a layer including a precursor, that is, a polysilazane, and is disposed between the cured layers 11. For example, the uncured layer 12 includes silicon atoms (Si), oxygen atoms (O), and nitrogen atoms (N). Because the uncured layer 12 includes nitrogen atoms, it may function as a stress buffer layer of the multi-layered barrier film 10 as well as a gas barrier layer.

A nitrogen atom concentration in the uncured layer 12 is not particularly limited as long as it is greater than 0. It may be greater than 10 atomic % and less than 40 atomic %, for example, about 10 atomic % to about 30 atomic %. When the nitrogen atom concentration is within these ranges, gas barrier properties of the multi-layered barrier film 10 are improved, and crack generation may be suppressed.

At least one layer of the uncured layer 12 may be included in the multi-layered barrier film 10 as shown in FIG. 1. Two or more layers of the uncured layer 12 may also be included. A layer thickness of the uncured layer 12 is not particularly limited, but may, for example, be about 5 nm to about 150 nm, and for example about 30 nm to about 100 nm, to avoid crack suppression.

The layer thickness of the uncured layer 12 is also controlled by an exposure dose of ultraviolet (UV) rays. The exposure dose may, for example, be about 0.3 to about 65 J/cm², for example about 2 to about 45 J/cm², and for example about 5 to about 38 J/cm², so that the layer thickness of the uncured layer 12 may be within the above ranges.

As the exposure dose becomes larger, the layer thickness of the uncured layer 12 becomes smaller, and the nitrogen atom concentration in the uncured layer 12 also becomes smaller. In addition, as the layer thickness of the polysilazane precursor layer becomes larger, the thickness of the uncured layer 12 at the same exposure dose increases. A concentration of the polysilazane photocurable precursor in the uncured layer 12 may be uniform or may increase in a direction from each cured layer 11 to a center of the uncured layer 12.

The gradient composition layer 13 is disposed between the cured layer 11 and the uncured layer 12, and as a distance from the surface of the cured layer 11 to the uncured layer 12, that is, a vertical cross-section in a thickness direction of the multi-layered barrier film 10, increases, a precursor concentration also increases. In other words, a concentration of the polysilazane photocurable precursor in the gradient composition layer 13 may increase in a direction from each cured layer 11 toward the uncured layer 12.

In an embodiment, the gradient composition layer 13 includes silicon atoms (Si), oxygen atoms (O), and nitrogen atoms (N). As the nitrogen atom concentration in each internal area becomes greater, a distance from the surface of the cured layer 11 to each internal area becomes longer. That is, the nitrogen atom concentration is less in an area close to the cured layer 11, and the nitrogen atom concentration is greater in an area close to the uncured layer 12.

In an embodiment, the nitrogen atom concentration in gradient composition layer 13 is greater than about 0 and less than about 20 atomic %, and for example, greater than or equal to about 1 atomic % and less than about 10 atomic %. When the nitrogen atom concentration is within these ranges, gas barrier properties of the multi-layered barrier film 10 are improved, and crack generation may be suppressed.

A plurality of the gradient composition layers 13 may be included in the multi-layered barrier film 10 as shown in FIG. 1, and at least one gradient composition layer may be included. A layer thickness of the gradient composition layer 13 is not particularly limited, and may be, for example, about 20 nm to about 100 nm, for example, about 10 nm to about 90 nm, and for example, about 30 nm to about 60 nm in terms of crack suppression.

The layer thickness of the gradient composition layer 13 is controlled by an exposure dose of ultraviolet (UV) rays. The exposure dose may, for example, be about 0.3 to about 65 J/cm², for example, about 2 to about 45 J/cm², and for example, about 5 to about 38 J/cm², so that the layer thickness of the gradient composition layer 13 may be within the above ranges.

As the exposure dose becomes greater, the layer thickness of the gradient composition layer 13 becomes less, and the nitrogen atom concentration in the gradient composition layer 13 also becomes less. In addition, as the layer thickness of the polysilazane precursor layer becomes larger, the gradient composition layer 13 at the same exposure dose becomes thicker.

In this way, because the multi-layered barrier film 10 has a multi-layer structure, barrier properties may be improved. In addition, the multi-layered barrier film 10 is formed by irradiating ultraviolet (UV) rays to a polysilazane-containing single precursor layer, and thus inclusion of foreign particles may be suppressed, and furthermore, generation of pinholes and cracks by foreign particles may also be suppressed. Therefore, the multi-layered barrier film 10 may have improved gas barrier properties in this regard.

The uncured layer 12 and the gradient composition layer 13 in the multi-layered barrier film 10 functions as a stress buffer layer, and thus generation of cracks by internal stress may be suppressed when ultraviolet (UV) rays are irradiated on to a thick-film precursor layer.

The atomic concentration of nitrogen and oxygen is continuously changed between the cured layer 11 and the gradient composition layer 13. Likewise, the atomic concentration is continuously changed between the gradient composition layer 13 and the uncured layer 12. Therefore, the multi-layered barrier film 10 has a multi-layer structure, but interfaces between layers are not substantially present. Therefore, internal stress is reduced, and furthermore crack generation may be suppressed. In addition, the layers are firmly bound to each other, and thus gas barrier properties may be improved. In an embodiment, the layers 11, 12, and 13 may be referred to as regions, where the interfaces are not detectable.

Method of Manufacturing Barrier Film

Next, a method of manufacturing the multi-layered barrier film 10 is described.

The multi-layered barrier film 10 is manufactured by a very simple process. The method of manufacturing the multi-layered barrier film 10 includes preparing a precursor layer by coating a substrate 20 with a polysilazane-containing coating solution and drying the same, and irradiating ultraviolet (UV) rays under an atmosphere including at least one of oxygen and a vapor precursor layer.

Coating Substrate with Coating Solution and Drying the Same

First, the polysilazane-containing coating solution is coated on the substrate 20 and dried, to prepare a precursor layer.

A coating method of the polysilazane-containing coating solution on the substrate 20 is not particularly limited, and any well-known method may be used. The coating method of the polysilazane-containing coating solution may be, for example, a spin coating method, a roll coating method, a flow coating method, an inkjet method, a spray coating method, a printing method, a dipping method, a flow casting film-forming method, a bar coating method, a gravure printing method, or the like, or a combination thereof.

A coating thickness of the coating solution on the substrate 20 may be determined according to desired purposes. For example, the coating thickness may be determined so that a thickness after drying, that is, a thickness of a precursor layer, may for example, be about 30 nm to about 750 nm, for example, about 40 nm to about 600 nm, and for example, about 45 nm to about 500 nm.

Radiating Ultraviolet (UV) to Precursor Layer

Subsequently, ultraviolet (UV) rays are irradiated to the precursor layer under an atmosphere including at least one of oxygen and a vapor. Accordingly, the multi-layered barrier film 10 is formed. In this process, conversion treatment of the precursor layer into silica is performed.

Herein, conversion treatment into silica is described.

It is reported that the polysilazane is converted into silicon nitride by being sintered under a nitrogen or ammonia atmosphere at a high temperature, whereas it is converted into silica when ultraviolet (UV) rays are irradiated to polysilazane. It is also reported that the polysilazane is converted into silica by being calcined under an atmosphere including at least one of oxygen and a vapor, from room temperature to a low temperature of about 450° C.

In an embodiment, ultraviolet (UV) irradiation may be suitably used. Active oxygen and ozone are generated by irradiating ultraviolet (UV) rays onto polysilazane under an atmosphere including at least one of oxygen and a vapor, and the active oxygen and ozone may promote a conversion reaction of the polysilazane into silica.

The active oxygen and ozone have very high reactivity. For example, the polysilazane-containing precursor layer is directly oxidized by the active oxygen and ozone without passing through silanol, and thereby a silicon oxide layer having high density without defects, that is, a multi-layered barrier film 10, is manufactured.

On the other hand, it is assumed that under a vapor atmosphere, hydroxyl radicals are generated. The hydroxyl radicals also have very high reactivity, like the active oxygen and ozone. While not wishing to be bound by theory, it is assumed that a conversion reaction into silica is promoted by hydroxyl radicals generated by vapor in the substrate 20 at a rear side of the precursor layer, that is, a side contacting the substrate 20.

Herein, ozone around the precursor layer may be deficient during irradiation of ultraviolet (UV) rays. Accordingly, in the present embodiment, ozone is prepared by other equipment that is different from the ultraviolet (UV) ray irradiating equipment, and the ozone may be introduced into a reaction area of the precursor layer.

A wavelength of the ultraviolet (UV) rays is not particularly limited, and may, for example, be about 100 nm to about 450 nm, for example, about 150 nm to about 300 nm, for example, about 100 nm to about 200 nm, and for example, about 150 nm to about 200 nm. When the wavelength of the ultraviolet (“UV”) rays is within the range, photon energy of the ultraviolet (UV) rays is larger, and a conversion reaction into silica may be accelerated.

In other words, when the ultraviolet (UV) rays have a wavelength ranging from about 100 to about 200 nm, the ultraviolet (UV) rays have photon energy larger than a bond energy between atoms in the compound, so active oxygen, ozone, and hydroxyl radicals may be easily produced from oxygen and vapor, and each bond in the polysilazane may be easily broken. Oxygen from the active oxygen, ozone, and hydroxyl radicals are inserted into the broken bond of the polysilazane and convert the polysilazane into silica. Accordingly, the conversion into silica proceeds at a relatively low temperature.

An ultraviolet (UV) light source is not particularly limited, and may be, for example, an inert gas excimer lamp, a low pressure mercury lamp, a deuterium lamp, a metal halide lamp, a plasma rinse lamp, and the like. Of these light sources, the inert gas excimer lamp may be particularly suitable since the inert gas excimer lamp emits ultraviolet (UV) rays having a wavelength of about 100 to about 200 nm. Of the inert gas excimer lamps, a xenon excimer lamp may be particularly suitable.

Herein, the inert gas excimer lamp emits ultraviolet (UV) rays from an inert gas by providing the inert gas with energy by discharge, and the like. As used herein, the term “inert gas” refers to a gas including atoms such as Xe, Kr, Ar, Ne, and the like, which are not chemically bonded to each other, and do not form molecules. However, inert gas atoms (excited atoms) obtaining energy by discharge bind with other inert gas atoms to form molecules. When the inert gas atoms are xenon atoms, xenon molecules are formed by the following Chemical Formulas 3 and 4.

e+Xe→e+Xe* Chemical Formula 3

Xe*+Xe+Xe→Xe₂*+Xe Chemical Formula 4

Excited excimer molecules Xe₂* emit excimer light of 172 nm, that is, ultraviolet (UV), when they transit to a ground state. The inert gas excimer lamp concentrates on irradiation with one wavelength without irradiating almost any other wavelengths, and thus increases efficiency of the conversion reaction into silica.

On the other hand, a xenon excimer lamp additionally has higher luminous efficiency than other inert gas excimer lamps, and also, a quartz glass may be used to manufacture a lamp for large area irradiation. In addition, the xenon excimer lamp emits ultraviolet (UV) rays having a wavelength of 172 nm, and the ultraviolet (UV) rays have a high oxygen absorption coefficient. Accordingly, the ultraviolet (UV) rays may generate oxygen atoms (i.e., active oxygen) and ozone in a high concentration with a small amount of oxygen. In addition, the ultraviolet (UV) rays having a wavelength of 172 nm may efficiently cleave a bond among atoms in an organic material. Accordingly, the xenon excimer lamp as a light source may efficiently generate ozone and active oxygen in a high concentration and cleave a bond between the atoms of polysilazane, and thus promote a conversion reaction into silica in a short time. In addition, the polysilazane and the substrate 20 may be easily damaged by heat, but carrying out the conversion reaction of the polysilazane and the substrate 20 into silica in a short time may prevent extreme exothermicity. Furthermore, since the conversion reaction into silica is efficiently performed by using the xenon excimer lamp, equipment may be expected to have a smaller size.

The other inert gas excimer lamps may emit ultraviolet (UV) rays having a wavelength ranging from about 100 to about 200 nm, but are not expected to produce the same effect as that of the xenon lamp. Accordingly, the xenon excimer lamp may be particularly preferable in the present embodiment.

Output, intensity of illumination, and irradiation energy of the light source are not particularly limited, as long as they are in a range of obtaining the aforementioned effects. For example, the light source may generate an output ranging from about 400 watts (“W”) to about 30 kW. The intensity of illumination may be in a range of about 5 milliwatts per square centimeter (“mW/cm²”) to about 100 kW/cm², for example, about 1 mW/cm² to about 10 W/cm². The irradiation energy may be in a range of about 1 mJ/cm² to about 5,000 mJ/cm², for example, about 10 mJ/cm² to about 2,000 mJ/cm². In addition, the light source may irradiate light more discretionally as well as constantly, and a plurality of irradiations may be performed with a short term pulse.

Exemplary Variation

Next, an exemplary variation according to the present embodiment is described.

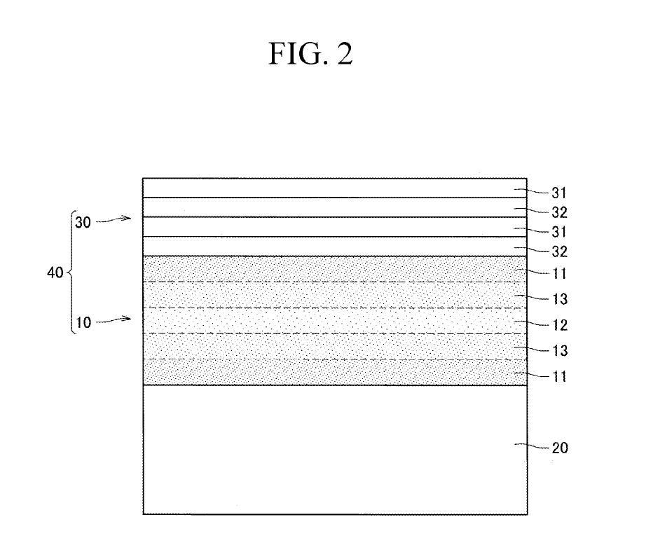

First, referring to FIG. 2, a barrier film 40 according to exemplary variation is described.

The barrier film 40 includes a multi-layered barrier film 10 and an alternative stacking film 30.

Structure of Alternative Stacking Film

The alternative stacking film 30 is stacked on the surface of the multi-layered barrier film 10. First, the alternative stacking film 30 may be stacked on the substrate 20, and the multi-layered barrier film 10 may then be stacked thereon. The multi-layered barrier film 10 and the alternative stacking film 30 may be alternatively stacked (Example 4). The alternative stacking film 30 includes an inorganic sheet-shaped particle layer 31 and a binder layer 32. The inorganic sheet-shaped particle layer 31 and the binder layer 32 are alternatively stacked.

Such an alternative stacking film 30 and polysilazane or polysilazane have high affinity for converted silicon dioxide to provide the barrier film 40 according to exemplary variation.

On the other hand, in FIG. 2, the binder layer 32 is stacked on the cured layer 11 because affinity between the binder layer 32 and the cured layer 11 is higher than affinity between the inorganic sheet-shaped particle layer 31 and the cured layer 11. The inorganic sheet-shaped particle layer 31 may be stacked on the cured layer 11. Hereinafter, a film obtained during manufacture of the alternative stacking film 30, that is, a film where at least one of the inorganic sheet-shaped particle layer 31 and the binder layer 32 is stacked on the surface of the multi-layered barrier film 10, may be referred to as an “intermediate film”.

Structure of Inorganic Sheet-Shaped Particle Layer

Next, the inorganic sheet-shaped particle layer 31 constituting the alternative stacking film 30 is described. The inorganic sheet-shaped particle layer 31 consists of sheet-shaped particles, for example, inorganic sheet-shaped particles.

The inorganic sheet-shaped particles may be obtained by layer-separating (exfoliating) an inorganic layered compound, for example a clay mineral such as mica, vermiculite, montmorillonite, iron montmorillonite, beidellite, saponite, hectorite, stevensite, nontronite, and the like, zirconium phosphate, a layered double hydroxide (“LDH”), and the like.

This inorganic layered compound include a plurality of inorganic sheet-shaped particles charged with a positive (+) charge or a negative (−) charge, that are stacked while being interposed with interlayer ions (for example sodium ions) charged with a charge opposite to that of the inorganic sheet-shaped particles. In order to separate layers of the inorganic layered compound, for example, particles having a larger particle diameter than the interlayer ions, for example water molecules, calcium ions, tetrabutylammonium ions, and the like may be interposed between the inorganic sheet-shaped particles. For example, the inorganic layered compound may be put in water and then agitated.

The inorganic sheet-shaped particle layer 31 may consist of one kind of inorganic sheet-shaped particles, or may consist of at least two different kinds of inorganic sheet-shaped particles having the same charge.

On the other hand, easy separation of layers may depend on a charge density of the inorganic layered compound. The inorganic layered compound to be easily layer-separated may be montmorillonite or zirconium phosphate. These inorganic layered compounds may be suitable in terms of easy layer separation.

The inorganic sheet-shaped particles have very flat shape, and consist of an inorganic material such as a metal oxide and the like. The inorganic sheet-shaped particles do not permeate gases. Accordingly, the inorganic sheet-shaped particles are disposed in a parallel direction relative to other layers, and thereby barrier performance of the barrier film 40 may be improved.

The inorganic sheet-shaped compound may have, for example, a diameter in a planar direction of about 10 nm to about 10 μm, and a thickness of about 1 to about 100 nm. On the other hand, the diameter in a planar direction is, for example, an arithmetic mean of diameters of each particle (a diameter when a shape of particle in a planar direction is considered to be a circle), and the thickness is an arithmetic mean of thickness of each particle.

The diameter in a planar direction and the thickness of the inorganic sheet-shaped compound particles are measured with, for example, SEM (scanning electron microscope), AFM (atomic force microscopy), or a laser scattering particle distribution measurer.

The inorganic sheet-shaped particles may be charged with a positive (+) or negative (−) charge as described above. For example, inorganic sheet-shaped particles obtained from a clay mineral such as mica, vermiculite, montmorillonite, iron montmorillonite, beidellite, saponite, hectorite, stevensite, nontronite, and the like and zirconium phosphate are charged with a negative (−) charge.

Inorganic sheet-shaped particles obtained from a layered double hydroxide are charged with a positive charge. The layered double hydroxide is represented by the following Chemical Formula 5.

[M²⁺₍₁₋ₓ₎M³⁺ₓ(OH)₂]^{x+}[Aⁿ⁻_{x/n}.yH₂O]^{x-} Chemical Formula 5

In Chemical Formula 5,

M²⁺ is a divalent metal,

M³⁺ is a trivalent metal,

A is an anion,

n is the number of anions,

x is a real number of 0<x<0.4, and

y is a real number of greater than 0.

That is, the layered double hydroxide is an inorganic layered compound that includes interlayer ions ([Aⁿ⁻_{x/n}.yH₂O]^{x-}) charged with a negative (−) charge and consisting of an anion and an interlayer material between layers of inorganic sheet-shaped particles ([M²⁺₁₋ₓM³⁺ₓ(OH)₂]^{x+}) charged with a positive (+) charge and having a structure such as brucite.

Electrical neutrality in the entire crystal of the layered double hydroxide is maintained. For a divalent metal, Mg, Mn, Fe, Co, Ni, Cu, Zn, and the like are known, and for a trivalent metal, Al, Fe, Cr, Co, In, and the like are known. For an anion, OH⁻, F⁻, Cl⁻, NO₃⁻, SO₄²⁻, CO₃²⁻, Fe(CN)₆⁴⁻, CH₃COO⁻, V₁₀O₂₈⁶⁻, dodecyl SO₄²⁻ and the like are known.

The inorganic sheet-shaped particle layer 31 is formed by an adsorption method. The adsorption method includes dipping a surface-charged substrate in a dispersion including particles charged with an opposite charge to the substrate. In this method, the particles are adsorbed on the surface of the substrate by a coulombic force. In this embodiment, the multi-layered barrier film 10 or the intermediate film including the binder layer 32 at the surface thereof is dipped in a dispersion including inorganic sheet-shaped particles that are charged with a charge opposite to that of the multi-layered barrier film 10 or the surface charge of the intermediate film. Accordingly, the inorganic sheet-shaped particles are adsorbed on the surface of the multi-layered barrier film 10 or intermediate film. Herein, the inorganic sheet-shaped particles are adsorbed to be parallel on the surface of the multi-layered barrier film 10 or intermediate film.

The inorganic sheet-shaped particles are prepared into a dispersion by injecting an inorganic layered compound into water and agitating the mixture. Herein, the inorganic layered compound may be used in a concentration ranging from about 0.01 to about 10 grams per liter (g/L), for example, about 0.1 to about 1 g/L. When the concentration is extremely low, the inorganic sheet-shaped particles are insufficiently adsorbed in the multi-layered barrier film 10 or the intermediate film. On the contrary, when the concentration is extremely high, the dispersion has higher viscosity. The dispersion includes at least water and the inorganic layered compound (for example inorganic sheet-shaped particles and interlayer ions produced through layer-separation of the inorganic layered compound), but may include a dispersing agent for increasing dispersity of the inorganic sheet-shaped particles and an intercalator for promoting layer separation of the inorganic layered compound.

Structure of Binder Layer

The binder layer 32 consists of binder particles charged oppositely to the inorganic sheet-shaped particle layer 31. These binder particles may include, for example, polymer electrolyte ions, metal ions, metal compound ions, and inorganic sheet-shaped particles. The binder layer 32 may include one kind or a mixture of two or more kinds out of these materials.

The polymer electrolyte ions may include, for example, polymer electrolyte ions and the like in which nitrogen atoms of polyallylamine hydrochloride (“PAH”) and polyacrylamide have a coordination bond with a proton. The metal ions may include ions such as aluminum ions, magnesium ions, potassium ions, polyvalent transition metal ions, and the like. The polyvalent transition metal may include iron, cobalt, manganese, and the like. The metal compound ion may include oxo acid ions of a metal, for example, VO₃⁻, MoO₄²⁻, WO₄²⁻, TiO²⁺, and the like. The inorganic sheet-shaped particles are obtained by layer-separating the inorganic layered compound. In other words, when the inorganic sheet-shaped particle layer 31 consists of inorganic sheet-shaped particles obtained from a clay mineral, the binder layer 32 consists of inorganic sheet-shaped particles obtained from a layered double hydroxide. On the contrary, when the inorganic sheet-shaped particle layer 31 consists of the inorganic sheet-shaped particles obtained from a layered double hydroxide, the binder layer 32 consists of inorganic sheet-shaped particles obtained from a clay mineral.

The binder layer 32 is formed in the adsorption method like the inorganic sheet-shaped particle layer 31. In the present embodiment, the multi-layered barrier film 10 or the intermediate film surface having the inorganic sheet-shaped particle layer 31 on the surface is dipped in a binder layer material aqueous solution (or a dispersion) charged oppositely to the surface of the multi-layered barrier film 10 or the surface of the intermediate film. Accordingly, the binder layer material is adsorbed on the surface of the multi-layered barrier film 10 or the intermediate film. In other words, the binder layer 32 is formed on the surface of the multi-layered barrier film 10 or the intermediate film. Herein, when the binder layer material becomes the inorganic sheet-shaped particles, the inorganic sheet-shaped particles are absorbed parallel to the surface of the multi-layered barrier film 10 or the intermediate film.

The binder particle aqueous solution (or dispersion) is obtained by dissolving or dispersing various water-soluble compounds or the aforementioned inorganic layered compound in water. Herein, the water-soluble compound or inorganic layered compound may be included in a concentration ranging from about 0.1 milligrams per liter (mg/L) to about 1 g/L, for example, about 1 mg/L to about 10 mg/L. When the concentration is extremely low, binder particles are insufficiently adsorbed in the multi-layered barrier film 10 or the intermediate film. On the other hand, when the concentration is extremely high, viscosity of the binder particle aqueous solution (or dispersion) becomes high. The binder particle aqueous solution (or dispersion) includes at least water and binder particles, but when the binder particles are inorganic sheet-shaped particles, the binder particle aqueous solution may include a dispersing agent for increasing dispersity of the inorganic sheet-shaped particles and an intercalator for promoting layer separation of the inorganic layered compound layer.

When the binder particles are polymer electrolyte ions, a water-soluble compound may be, for example, an ionic polymer such as a polyallylamine hydrochloride salt, polyacrylic acid, and the like. When the binder layer 32 consists of metal ions, a water-soluble compound may include a sulfate, a chloride, or a hydroxide of a metal, for example, AlK(SO₄)₂, AlNH₄(SO₄)₂, MgCl₂, Mg(NO₃)₂, KOH, K₂SO₄, KCl, FeK(SO₄)₂, CoCl₂, Co(NO₃)₂, MnCl₂, Mn(NO₃)₂, NiCl₂, Ni(NO₃)₂, CuCl₂, Cu(NO₃)₂, ZnCl₂, Zn(NO₃)₂, and the like. When the binder layer 32 consists of metal compound ions, the water-soluble compound may be a sodium salt or ammonium salt of oxo acid, for example, NaVO₃, (NH₄)₂MoO₄, (NH₄)₂WO₄, TiOSO₄, and the like.

Method of Manufacturing Alternative Stacking Film

Next, a method of manufacturing the alternative stacking film 30 is described.

Herein, a method of stacking the inorganic sheet-shaped particle layer 31 on the multi-layered barrier film 10 and subsequently the binder layer 32 on the inorganic sheet-shaped particle layer 31 is illustrated, but the binder layer 32 may be stacked on the multi-layered barrier film 10.

First Step: Treatment for Forming Inorganic Sheet-Shaped Particle Layer

Subsequently, the inorganic sheet-shaped particle layer 31 is formed on the negatively-charged surface of the multi-layered barrier film 10. In an embodiment, an inorganic sheet-shaped particle dispersion is prepared by injecting at least one of a clay mineral and zirconium phosphate into water and agitating the mixture. On the other hand, the clay mineral and the zirconium phosphate is stacked when negatively (−)-charged inorganic sheet-shaped particles interpose interlayer ions. Subsequently, the multi-layered barrier film 10 is dipped in the inorganic sheet-shaped particle dispersion. Accordingly, the inorganic sheet-shaped particles are adsorbed on the surface of the multi-layered barrier film 10. In other words, the inorganic sheet-shaped particle layer 31 is formed on the surface of the multi-layered barrier film 10.

Second Step: Treatment for Forming Binder Layer

Subsequently, the binder layer 32 is formed on the inorganic sheet-shaped particle layer 31. In an embodiment, a binder particle aqueous solution (or a dispersion) is prepared by dissolving (or dispersing) at least one from positively (+)-charged polymer electrolyte ions, metal ions, metal compound ions, and positively (+)-charged inorganic sheet-shaped particles. An intermediate film having the inorganic sheet-shaped particle layer 31 on the surface is then dipped in the binder particle aqueous solution (or the dispersion). Accordingly, binder particles are adsorbed on the surface of the intermediate film. In other words, the binder layer 32 is formed on the surface of the intermediate film. Herein, when the binder particles are inorganic sheet-shaped particles, the inorganic sheet-shaped particles are adsorbed parallel to the surface of the intermediate film.

Third Step: Repeated Treatment

Subsequently, the first and second steps are repeated to stack the inorganic sheet-shaped particle layer 31 and the binder layer 32 on the multi-layered barrier film 10. Accordingly, the alternative stacking film 30 is manufactured.

The alternative stacking film 30 stacked in the multi-layered barrier film 10 is examined by using, for example, an atomic force microscope (“AFM”).

Hereinafter, the present disclosure is illustrated in more detail with reference to examples. However, these examples are exemplary, and the present disclosure is not limited thereto.

### Example 1

Hereinafter, Example 1 of the present embodiment is illustrated.

Manufacture of Multi-Layered Barrier Film

A multi-layered barrier film according to Example 1 is manufactured according to the following steps.

Rinsing Substrate

TeonexQ65FA (a 0.2 mm-thick PEN film) made by Teijin Dupont Film Inc. is prepared as a substrate. The substrate is rinsed with a detergent and pure water and dried with an air blower.

Manufacture of Polysilazane Precursor Layer

Aquamica NN110 made by AZ Electronic Materials Co., Ltd. as a perhydropolysilazane-containing coating solution is spin-coated on the rinsed substrate. This coating solution does not include a catalyst. The coating solution is the dried at 100° C. for 15 minutes. Accordingly, a polysilazane precursor layer is formed on the substrate.

Conversion Treatment into Silica

A polysilazane precursor is then converted into silica by using a xenon excimer lamp. The treatment condition is described later. Accordingly, the multi-layered barrier film according to Example 1 is manufactured. The multi-layered barrier film is about 400 nm thick.

Treatment Condition

Ultraviolet (UV) Wavelength: 172 nm

Ultraviolet (UV) Intensity of Illumination: 20 mW/cm²

Distance between Precursor Layer and Light Source: 2 mm

Ultraviolet (UV) Irradiation Time: 15 minutes (an exposure dose: 18 J/cm²)

Reaction Atmosphere Ambient Atmosphere

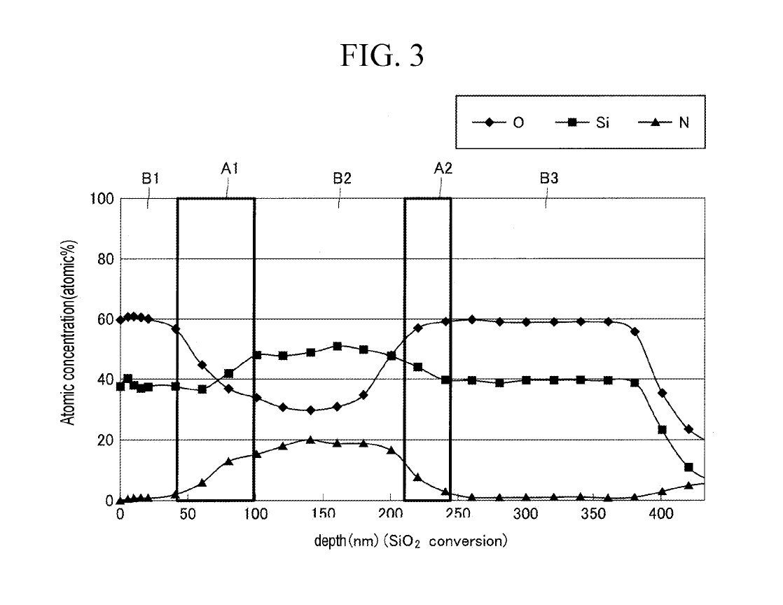

XPS analysis results of the multi-layered barrier film are provided in FIG. 3 and Table 1.

In FIG. 3, a horizontal axis indicates a depth (a distance from the surface of the multi-layered barrier film inside the internal area of the particular layer), and a vertical axis indicates an atom concentration. Areas B1 and B3 correspond to a cured layer, and the area B2 corresponds to an uncured layer. In addition, the area A1 corresponds to a first gradient composition layer, and the area A2 corresponds to a second gradient composition layer.

As shown in FIG. 3, the first gradient composition layer, that is, a gradient composition layer closest to the surface of the multi-layered barrier film, is formed in a depth of about 40 nm from the surface of the multi-layered barrier film. The cured layer consists of silicon and oxygen and has a nitrogen atom concentration of almost zero (0). The first gradient composition layer consists of silicon, oxygen, and nitrogen, and each internal area has a higher nitrogen atom concentration as the distance from the surface of the first gradient composition layer inside the internal area thereof is greater. Furthermore, the second gradient composition layer consists of silicon, oxygen, and nitrogen, and each internal area has a lower nitrogen atom concentration as the distance from the surface of the second gradient composition layer inside the internal area thereof is greater. In other words, as a distance from the cured layer on the back of the second gradient composition layer to each internal area is longer, the internal area has a higher nitrogen atom concentration. The uncured layer consists of silicon, oxygen, and nitrogen. Since each atom has a constantly changing atom concentration, there is substantially no interface between interlayers. Furthermore, according to Table 1, each layer has a nitrogen atom concentration and a thickness satisfying the aforementioned condition.

### Example 2

Hereinafter, Example 2 of the present embodiment is illustrated.

Manufacture of Multi-Layered Barrier Film

A multi-layered barrier film of Example 2 is manufactured according to the following steps.

Rinsing Substrate

TeonexQ65FA (a 0.2 mm thick PEN film) from Teijin DuPont Film Inc. as a substrate is prepared. The substrate is rinsed with a detergent and pure water and dried with an air blower.

Manufacture of Polysilazane Precursor Layer

Aquamica NL110 made by AZ Electronic Materials Co., Ltd. as a perhydropolysilazane-containing coating solution is spin-coated on the rinsed substrate. This coating solution includes palladium as a catalyst. Subsequently, the coating solution is dried at 100° C. for 15 minutes, forming a polysilazane precursor layer on the substrate.

Conversion Treatment into Silica

Subsequently, the polysilazane precursor layer is converted into silica by using a xenon excimer lamp. The treatment is performed under conditions that will be explained later. Accordingly, the same multi-layered barrier film as that of Example 1 is manufactured. The multi-layered barrier film is about 550 nm thick.

Treatment Condition

Ultraviolet (UV) Wavelength: 172 nm

Ultraviolet (UV) Intensity of Illumination: 20 mW/cm²

Distance between Precursor Layer and Light source: 2 mm

Ultraviolet (UV) irradiation time: 30 minutes (exposure dose 36 J/cm²)

Reaction Atmosphere Ambient atmosphere

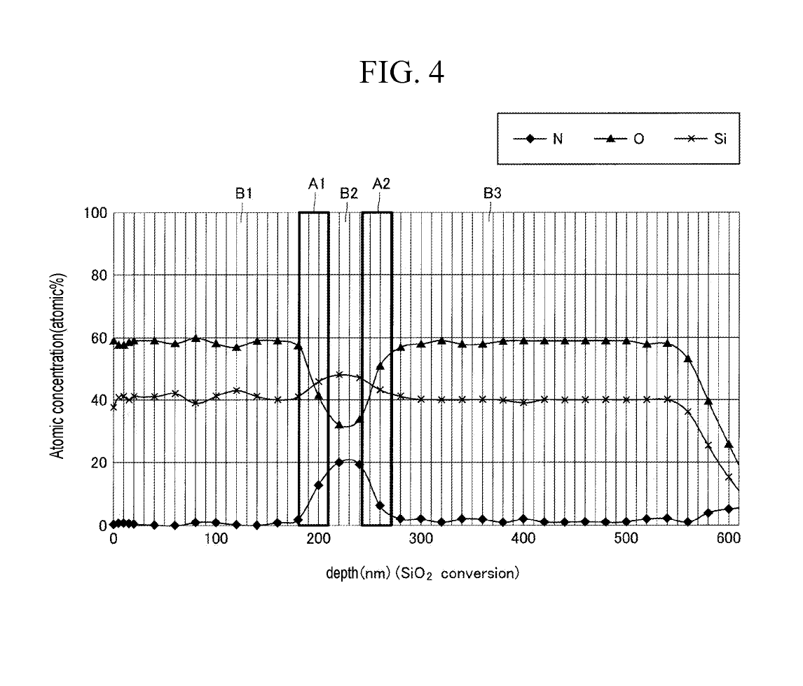

XPS analysis result of the multi-layered barrier film is provided in FIG. 4 and Table 1.

In FIG. 4, a horizontal axis indicates a depth (a distance from the surface of the multi-layered barrier film), and a vertical axis indicates an atom concentration. Areas B1 and B3 correspond to a cured layer, and an area B2 corresponds to an uncured layer. In addition, an area A1 corresponds to a first gradient composition layer, and an area A2 corresponds to second gradient composition layer.

According to FIG. 4 and Table 1, even though the coating solution includes a catalyst, the same multi-layered barrier film as that of Example 1 is manufactured. However, since an exposure dose in Example 2 is more than in Example 1, the cured layer is thicker than that of Example 1, while the uncured layer and gradient composition layer is thinner than that of Example 1.

### Example 3

Hereinafter, Example 3 of the present embodiment is illustrated.

Manufacture of Multi-Layered Barrier Film

A multi-layered barrier film according to Example 3 is manufactured according to the following steps.

First, the same treatment as in Example 1 is performed to manufacture the same multi-layered barrier film as that of Example 1. An alternative stacking film is then stacked on the multi-layered barrier film by performing the following treatments.

Preparation of Inorganic Sheet-Shaped Particle Layer Solution

0.5 g of Kunifil-D36 manufactured by Kunimine Industries Co. as montmorillonite (“MMT”) is put in 1 liter (“L”) of pure water, and the mixed solution is agitated for one day with a commercially available stirrer. Accordingly, an inorganic sheet-shaped particle layer solution is prepared.

Preparation of Binder Layer Solution

30 millimoles per liter (“mM/L”) of a polyallylamine hydrochloride (“PAH”) aqueous solution as a binder layer solution is prepared.

Formation of Binder Layer

The multi-layered barrier film is dipped in the binder layer solution for 15 minutes, sufficiently washed with pure water, and dried with an air blower. Accordingly, a binder layer is formed on the multi-layered barrier film.

Formation of Inorganic Sheet-Shaped Particle Layer

The multi-layered barrier film having the binder layer, that is, the intermediate film, is dipped in an inorganic sheet-shaped particle layer solution for 15 minutes, sufficiently washed with pure water, and dried with an air blower. Accordingly, an inorganic sheet-shaped particle layer is formed on the intermediate film.

Alternative Adsorption

An alternative stacking film is formed on the multi-layered barrier film of Example 1 by alternatively repeating formation of the binder layer and the inorganic sheet-shaped particle layer 10 times. This alternative stacking film has 10 sets as one set of the binder layer and the inorganic sheet-shaped particle layer. XPS analysis results of the multi-layered barrier film according to Example 3 (the multi-layered barrier film of Example 1+the alternative stacking film) are provided in FIG. 3 and Table 1. The XPS analysis results are the same as those of Example 1. However, the WVTR may be improved compared with that of Example 1.

### Example 4

In Example 4, the multi-layered barrier film of Example 3 is manufactured and then is treated the same as in Example 1. In other words, another multi-layered barrier film is formed on the multi-layered barrier film of Example 3. The multi-layered barrier film of Example 4 (a multi-layered barrier film+an alternative stacking film+a multi-layered barrier film) is a total of 820 nm thick.

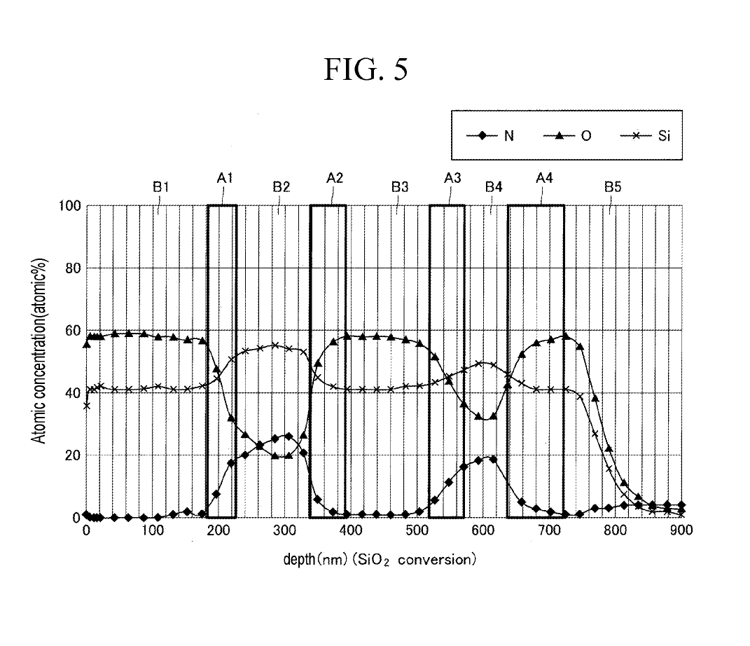

XPS analysis results of the multi-layered barrier film according to Example 4 are provided in FIG. 5 and Table 1.

In FIG. 5, a horizontal axis indicates a depth (a distance from the surface of a multi-layered barrier film), and a vertical axis indicates an atom concentration. Areas B1 and B5 correspond to a cured layer, and an area B2 and B4 corresponds to an uncured layer. In addition, an area A1 corresponds to a first gradient composition layer, and an area A2 corresponds to a second gradient composition layer. An area A3 corresponds to a third gradient composition layer, and an area A4 corresponds to a fourth gradient composition layer. As shown in FIG. 5 and Table 1, the gradient composition layer and the uncured layer in Example 4 are twice as large as in Example 1. Each layer has the same atom distribution as that of Example 1.

### Comparative Example 1

TeonexQ65FA (a 0.2 mm-thick PEN film) made by Teijin DuPont Film Inc. is prepared as a substrate. The substrate is rinsed with a detergent and pure water and dried with an air blower. Subsequently, Aquamica NN110 made by AZ Electronic Materials Co., Ltd. as a perhydropolysilazane-containing coating solution is spin-coated and dried at 100° C. for 15 minutes. Accordingly, a precursor layer is formed thereon. The precursor layer is then heat-treated at 250° C. for 60 minutes. Accordingly, a single silicon dioxide layer is formed. The layer is 400 nm thick.

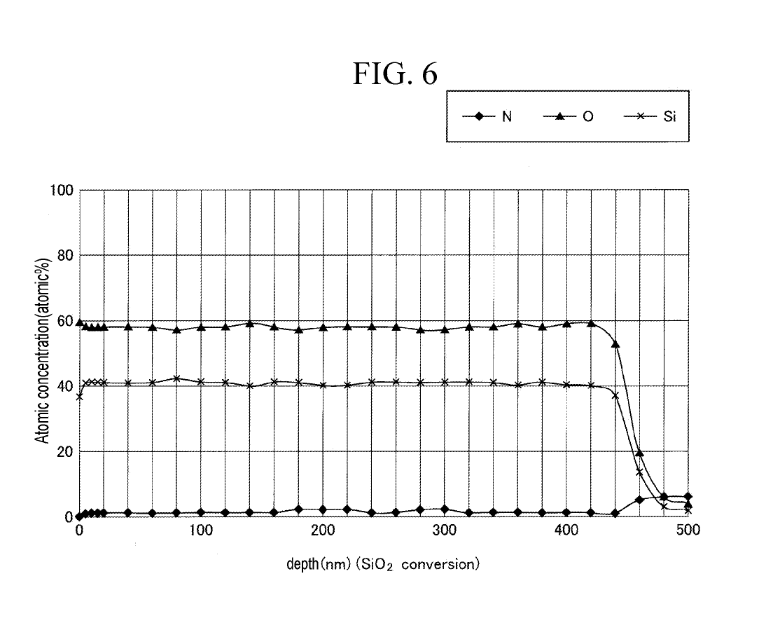

XPS analysis results of Comparative Example 1 are provided in FIG. 6 and Table 1. In FIG. 6, a horizontal axis indicates a depth (a distance from the surface of a multi-layered barrier film), and a vertical axis indicates an atom concentration. According to the analysis results, no multi-layer structure is formed in Comparative Example 1.

### Comparative Example 2

TeonexQ65FA (a 0.2 mm-thick PEN film) made by Teijin Dupont Film Inc. is prepared as a substrate. The substrate is rinsed with a detergent and pure water and dried with an air blower. Subsequently, a single silicon dioxide layer is formed on the substrate in a vacuum deposition method. The layer is 100 nm thick. Specifically, the substrate and a deposition material (herein, a silicon dioxide) are put in a container under vacuum to a degree of 10⁻³ to 10⁻⁴ Pa, and the deposition material is resistance-heated and evaporated. Accordingly, a single silicon dioxide layer is formed on the substrate. XPS analysis results of Comparative Example 2 are provided in Table 1. According to the analysis results, a multi-layer structure is not formed in Comparative Example 2.

### WVTR Measurement

The WVTR of the barrier films of Examples 1 to 4 and Comparative Examples 1 to 2 is measured by using a vapor permeability measuring device, AQUATRAN, made by MOCON Testing Laboratories. The results are provided in Table 1.

### Crack Evaluation

Crack evaluation of the barrier films of Examples 1 to 4 and Comparative Examples 1 to 2 is performed through a cross cut test (JIS K5400 Cross Cut Test, 100 grid). Specifically, a 100 grid test area is formed by cutting a plurality of perpendicular grid patterns on the barrier films. Subsequently, Sellotape (a registered trademark) is strongly pressed in a cell of the checkerboard, and the edge of the tape is peeled off at once time at an angle of 45°. Subsequently, the number of grids peeled off the substrate of the 100 grids is counted to perform the crack evaluation. The evaluation is performed under the following references. The results are provided in Table 1.

⊚: 0 grid (no crack)

0: less than or equal to 50 grids (a crack is not nearly present)×

x: greater than 50 grids (many cracks are present)

TABLE 1

| | | Ex. 1 | Ex. 2 | Ex. 3 | Ex. 4 | Comp. Ex. 1 | Comp. Ex. 2 |
|---|---|---|---|---|---|---|---|
| First gradient | N concentration | 2 ≦ N < 13 | 1 ≦ N < 15 | 2 ≦ N < 13 | 2 ≦ N < 17 | — | — |
| composition | (atomic %) | | | | | | |
| layer | Layer thickness | 50 | 30 | 50 | 45 | — | — |
| | (nm) | | | | | | |
| Uncured layer | N concentration | 13 ≦ N ≦ | 15 ≦ N ≦ 20 | 13 ≦ N ≦ | 17 ≦ N ≦ 26 | — | — |
| | (atomic %) | 20 | | 20 | | | |
| | Layer thickness | 70 | 50 | 70 | 100 | — | — |
| | (nm) | | | | | | |
| Second | N concentration | 3 ≦ N < 13 | 2 ≦ N < 15 | 3 ≦ N < 13 | 2 ≦ N < 17 | — | — |
| gradient | (atomic %) | | | | | | |
| composition | Layer thickness | 30 | 30 | 30 | 45 | — | — |
| layer | (nm) | | | | | | |
| Third gradient | N concentration | — | — | — | 2 ≦ N < 16 | — | — |
| composition | (atomic %) | | | | | | |
| layer | Layer thickness | — | — | — | 45 | — | — |
| | (nm) | | | | | | |
| Cured layer | N concentration | — | — | — | 16 ≦ N ≦ 19 | — | — |
| | (atomic %) | | | | | | |
| | Layer thickness | — | — | — | 60 | — | — |
| | (nm) | | | | | | |
| Fourth gradient | N concentration | — | — | — | 2 ≦ N < 16 | — | — |
| composition | (atomic %) | | | | | | |
| layer | Layer thickness | — | — | — | 85 | — | — |
| | (nm) | | | | | | |
| Film composition | | Multi | Multi | Multi/alternative | Multi/alternative | SO₂ single | SO₂ single |
| | | | | stack | stack/multi | layer | layer |
| Film thickness (nm) | | 400 | 550 | 420 | 820 | 400 | 100 |
| Method of forming barrier film | | Spin | Spin coat/ | Spin | Spin coat/ | Spin coat/ | Vacuum |
| | | coat/ | excimer | coat/ | excimer lamp | heat | deposition |
| | | excimer | lamp | excimer | | treatment | |
| | | lamp | | lamp | | | |
| WVTR | | 0.0005 | 0.001 | <0.0001 | <0.0001 | 0.2 | 0.05 |
| Crack | | ◯ | ◯ | ◯ | ◯ | X | ◯ |

In Table 1, “—”indicates there is no layer corresponding to the cell. In addition, “multi-layered” indicates a multi-layered barrier film according to the present embodiment, and “alternatively stack” indicates an alternative stacking film according to the present embodiment.

Referring to Table 1, the multi-layered barrier film of the present embodiment shows excellent barrier properties and suppression of crack and pinhole generation. In addition, the multi-layered barrier film including no catalyst shows better WVTR than the multi-layered barrier film including a catalyst. Furthermore, barrier properties of the multi-layered barrier film are improved by stacking an alternative stacking film thereon.

Hereinbefore, a multi-layered barrier film 10 according to the present embodiment includes a plurality of cured layers 11, an uncured layer 12, and a gradient composition layer 13. In other words, the multi-layered barrier film 10 has a multi-layer structure. Thus, in the multi-layered barrier film 10, barrier properties can be improved. In addition, the multi-layered barrier film 10 is suppressed from crack generation, because the uncured layer 12 and the gradient composition layer 13 functions as a stress buffer layer. The multi-layered barrier film 10 is manufactured by irradiating ultraviolet (UV) rays on a single precursor layer and is suppressed from being mixed with foreign particles, and thus from generation of cracks and pinholes by the foreign particles.

The cured layer 11 may have a thickness ranging from about 20 nm to 250 nm and further suppresses crack generation.

The gradient composition layer 13 may have a thickness ranging from about 20 nm to about 100 nm and further suppresses crack generation.

The uncured layer 12 has a thickness ranging from about 5 nm to about 150 nm and further suppresses crack generation.

Furthermore, the cured layer 11, the uncured layer 12, and the gradient composition layer 13 include at least two kinds of atoms selected from silicon atoms, oxygen atoms, and nitrogen atoms, and thus barrier properties of the multi-layered barrier film 10 are improved, while crack generation may be suppressed.

The gradient composition layer 13 includes silicon atoms, oxygen atoms, and nitrogen atoms, and an internal area has a higher nitrogen atom concentration as the internal area is farther from the cured layer 11, and in addition, the nitrogen atoms are included in an amount of about 0 atomic % to about 20 atomic % based on the total numbers of atoms in the gradient composition layer 13. Accordingly, the gradient composition layer 13 functions as a stress buffer layer and further suppresses crack generation.

The uncured layer 12 includes silicon atoms, oxygen atoms, and nitrogen atoms, and has a nitrogen atom concentration in a range of about 10 atomic % to about 40 atomic %. Accordingly, the uncured layer 12 may function as a stress buffer layer and further suppresses crack generation.

A multi-layered barrier film 40 according to the present embodiment has an alternative stacking film 30 and further improves barrier properties.

The alternative stacking film 30 includes inorganic sheet-shaped particles and may further improve barrier properties of the multi-layered barrier film 40.

The multi-layered barrier film 10 according to the present embodiment is manufactured by irradiating ultraviolet (UV) rays on a polysilazane-containing photocurable precursor layer with an exposure dose within a range of about 0.3 to about 65 J/cm², and herein, the exposure dose is larger as the precursor layer is thicker. Accordingly, the multi-layered barrier film 10 is manufactured in a very simple process. The multi-layered barrier film 10 has a multi-layer structure, and thus barrier properties may be improved. Furthermore, the multi-layered barrier film 10 is manufactured by irradiating ultraviolet (UV) rays on a single layer, is suppressed from being mixed with foreign particles, and is further protected from generation of cracks and pinholes by the foreign particles.

As described above, referring to accompanying drawings, embodiments of the present disclosure are described in detail, but the present disclosure is not limited thereto. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A barrier film comprising:
a plurality of cured layers, each cured layer comprising a curing product of a polysilazane photocurable precursor;
an uncured layer disposed between a first and a second cured layer of the plurality of cured layers, the uncured layer comprising the polysilazane photocurable precursor; and
a gradient composition layer disposed between the first and the second cured layer and the uncured layer,
wherein a concentration of the polysilazane photocurable precursor in the gradient composition layer increases with a distance from the first and the second cured layers toward the uncured layer.

2. The barrier film of claim 1, wherein the cured layer has a thickness in a range of about 20 nanometers to about 250 nanometers.

3. The barrier film of claim 1, wherein the gradient composition layer has a thickness ranging from about 20 nanometers to about 100 nanometers.

4. The barrier film of claim 1, wherein the uncured layer has a thickness ranging from about 5 nanometers to about 150 nanometers.

5. The barrier film of claim 1, wherein the first and second cured layers, the uncured layer, and the gradient composition layer each comprise silicon and oxygen, nitrogen, or a combination thereof.

6. The barrier film of claim 5, wherein the gradient composition layer comprises silicon, oxygen, and nitrogen,
wherein a concentration of the nitrogen in the gradient composition layer increases with a distance from the first and second cured layers toward the uncured layer, and
wherein the concentration of the nitrogen ranges from about 0 atomic % to about 20 atomic %, based on the total atomic content of the gradient composition layer.

7. The barrier film of claim 5, wherein the uncured layer comprises silicon, oxygen, and nitrogen, and
the concentration of the nitrogen in the uncured layer ranges from about 10 atomic % to about 40 atomic %, based on the total atomic content of the uncured layer.

8. The barrier film of claim 1, further comprising an alternative stacking film disposed on the plurality of cured layers, wherein the alternative stacking film comprises a sheet-shaped particle layer comprising charged sheet-shaped particles and a binder layer having a charge opposite to a charge of the sheet-shaped particles.

9. The barrier film of claim 8, wherein the sheet-shaped particles are inorganic sheet-shaped particles.

10. A method of manufacturing of a barrier film, the method comprising:
forming a polysilazane photocurable precursor layer; and
irradiating ultraviolet rays onto the polysilazane-containing photocurable precursor layer to manufacture the barrier film,
wherein an exposure dose of the ultraviolet rays ranges from about 0.3 joules per square centimeter to about 65 joules per square centimeter, and
wherein the exposure dose of the ultraviolet rays increases as a thickness of the precursor layer is increased.

11. The method of manufacturing of claim 10, wherein the barrier film comprises a plurality of cured layer having a thickness in a range of about 20 nanometers to about 250 nanometers.

12. The method of manufacturing claim 11, wherein the barrier film further comprises a gradient composition layer having a thickness ranging from about 20 nanometers to about 100 nanometers disposed between a first cured layer and a second cured layer of the barrier film.

13. The method of manufacturing of claim 12, wherein the barrier film further comprises an uncured layer having a thickness ranging from about 5 nanometers to about 150 nanometers disposed between the gradient composition layer and the first cured layer and the second cured layer.

14. The method of manufacturing of claim 13, wherein a concentration of the polysilazane photocurable precursor in the gradient composition layer increases with a distance from first and second cured layers toward the uncured layer.

15. The method of manufacturing of claim 14, wherein the gradient composition layer of the barrier film comprises silicon, oxygen, and nitrogen; and
wherein a concentration of the nitrogen in the gradient composition layer increases with a distance from the first and the second cured layers toward the uncured layer.

16. The method of manufacturing claim 10, wherein the barrier film further comprises an alternative stacking film disposed on the plurality of the cured layers, wherein the alternative stacking film comprises a sheet-shaped particle layer comprising charged sheet-shaped particles and a binder layer having a charge opposite to a charge of the sheet-shaped particles.

17. The method of manufacturing of claim 16, wherein the sheet-shaped particles are inorganic sheet-shaped particles.

18. The method of manufacturing of claim 16, wherein the sheet-shaped particle layer further comprises a dispersing agent and an intercalator.

19. An electronic device comprising the barrier film of claim 1.
